(19) United States
(12) Patent Application Publication
(10) Pub. No.: US 2002/0135848 A1
(43) Pub. Date: Sep. 26, 2002

(54) Optical scanning apparatus

(76) Inventor: In-Yong Lee, Suwon-si (KR)

Correspondence Address: Robert E. Bushnell, Suite 300, 1522 K Street, N.W., Washington, DC, 20005-1202, US

(21) Appl. No.: 09/946,680

(22) Filed: Sep. 6, 2001

(30) Foreign Application Priority Data
Jan. 20, 2001 (KR) 2001-3419

(51) Int. Cl. G02B 26/08; B41J 27/00

(52) U.S. Cl. 359/205; 359/207; 359/216; 347/259

(57) ABSTRACT

An-optical scanning apparatus includes a light source for emitting light, a deflector, rotated by a motor, for reflecting the light emitted from the light source, and a scanning lens for receiving the light reflected by the deflector and forming an appropriate light spot according to a scanning line on a photosensitive medium. The ratio between the thickness Tc of the scanning lens at the center thereof and the thickness Ts at the edge thereof satisfies the following equation, (T_{C}/T_{S})≦1.5. Thus, the optical surface which is a free curved surface can be accurately controlled. Also, since the influence by birefringence and internal stress can be minimized, the competitiveness of a product in the cost is improved. Furthermore, since the structure of the scanning lens is less affected by the change in the external environment such as heat characteristic, humidity and temperature, performance of a product is improved.

### CLAIM OF PRIORITY

This application makes reference to, incorporates the same herein, and claims all benefits accruing under 35 U.S.C §119 from an application entitled Optical Scanning Apparatus earlier filed in the Korean Industrial Property Office on Jan. 20, 2001, and there duly assigned Ser. No. 2001-3419 by that Office.

### BACKGROUND OF THE INVENTION

1. Field of the Invention

The present invention relates to an optical scanning apparatus having a scanning lens which is superior in processing by being less affected by manufacturing conditions during manufacture of the scanning lens.

2. Description of the Related Art

An optical scanning apparatus adopted in a laser beam printer or a digital copier scans a is laser beam onto a photosensitive medium such as a photoreceptor web to form an electrostatic latent image. In particular, more attention is paid to a scanning apparatus adopted in a color printer as a need for color print from a black and white print increases. A color laser printer includes scanning apparatus for four colors of yellow (Y), magenta (M), cyan (C), and black (BK).

Referring to FIG. 1, a typical optical scanning apparatus includes a light source 100, a deflector 105, rotated by a motor (not shown), for reflecting light from the light source 100, and a scanning lens 115 for receiving the light reflected by the deflector 105 and forming an appropriate light spot according to a scanning line 118 on a photosensitive medium, for example, a photosensitive drum 110. Here, a predetermined image is formed as an electrostatic latent image on the photosensitive drum 110 by turning the light source 100 on and off.

A collimating lens 122 for converting incident light to a parallel beam, a slit 130, and a cylindrical lens 135 are sequentially arranged on the optical path between the light source 100 and the deflector 105. The cylindrical lens 135 transmits light 120 passing through the slit 130 as a parallel beam in a main scanning direction and converts the light 120 to a convergent beam in a sub-scanning direction so that a linear image is formed on a reflecting surface 105a of the deflector 105.

In the optical scanning apparatus having the above structure, luminous flux optically modulated and emitted from the light source 100 according to an image signal is changed to a parallel luminous flux or convergent luminous flux by the collimating lens 122. The parallel beam proceeds toward the deflector 105 via the cylindrical lens 135. The luminous flux reflected by the deflector 105 is focused by the scanning lens 115 so that a light spot is formed at a point on the scanning line 118 on the photosensitive drum 110.

In the above optical scanning apparatus, the scanning lens 115 is a core part in exerting optical performance and is very difficult to be manufactured. In general, the scanning lens 115 is formed of one lens unit or two lens units.

Here, referring to FIG. 2 which shows the structure of the scanning lens 115, most optical surface of the scanning lens 115 is formed of a free curved surface and the thickness l of the lens at the center of scanning is 2-2.5 times thicker than the thickness n at the edge thereof. The scanning lens 115 having such a structure is usually manufactured by accurate injection molding using an accurate molding process and plastic material. Since the scanning lens 115 is not rotationally symmetrical, it is difficult to accurately manufacture the scanning lens 115 to have optical performance. In particular, accurately processing the edge portion of the scanning lens 115 is very difficult in manufacturing the scanning lens 115. Here, Z direction, Y direction, and X direction denote an optical axis direction, a main scanning direction, and a sub-scanning direction which is perpendicular to the main scanning direction, respectively.

Also, since the scanning lens 115 is formed of a free curved surface, and as the difference between the length m in the main scanning direction and the length P in the sub-scanning direction is great and the difference between the thickness l of the scanning lens 115 at the center of scanning and the thickness n at the edge thereof is great, birefringence and internal stress caused by a difference in pressure at each of scanning positions received during accurate manufacture are generated greatly so that conditions for processing are deteriorated and lens performance is lowered. Furthermore, since the scanning lens has a structure which is easily affected by external environmental conditions such as heat characteristic, humidity, and temperature, the scanning lens is easily deformed not only during the accurate manufacturing step, but also under a general environment in which the scanning lens is used.

Use of scanning lenses similar to that discussed above are found in the following patents incorporated by reference herein: U.S. Pat. No. 6,222,662 to Seizo Suzuki et al. entitled Optical Scanning Device And Scanning Lens Therefor; U.S. Pat. No. 6,069,724 to Yoshinori Hayashi et al. entitled Optical Scanning Lens And Optical Scanning Apparatus; and U.S. Pat. No. 6,154,245 to Manabu Kato entitled Optical Element And Scanning Optical Apparatus Using The Same.

### SUMMARY OF THE INVENTION

To solve the above problems, it is an object of the present invention to provide an optical scanning apparatus in which the ratio of the thicknesses of the scanning lens at the center and the edge of scanning is reduced so that the scanning lens is not less affected by the manufacturing environment or external environment when being manufactured or in use, respectively.

Accordingly, to achieve the above object, there is provided an optical scanning apparatus comprising a light source for emitting light, a deflector, rotated by a motor, for reflecting the light emitted from the light source, and a scanning lens for receiving the light reflected by the deflector and forming an appropriate light spot according to a scanning line on a photosensitive medium, wherein the ratio between the thickness Tc of the scanning lens at the center thereof and the thickness Ts at the edge thereof satisfies the following equation,

(T_{C}/T_{S})≦1.5

It is preferred in the present invention that the length (SL) of the scanning lens in a main scanning direction satisfies that SL<60 mm.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a view showing the optical arrangement of the conventional optical scanning apparatus;

FIG. 2 is a perspective view of a scanning lens of the convention optical scanning apparatus;

FIG. 3 is a view showing the optical arrangement of an optical scanning apparatus according to the present invention;

FIG. 4 is a plan view of the scanning lens of the optical scanning apparatus according to the present invention;

FIG. 5 is a graph showing f-θ feature with respect to the length in the main scanning direction in the optical scanning apparatus according to the present invention; and

FIG. 6 is a graph showing the change in the thickness of the scanning lens with respect to the length in the main scanning direction of the optical scanning apparatus according to the present invention.

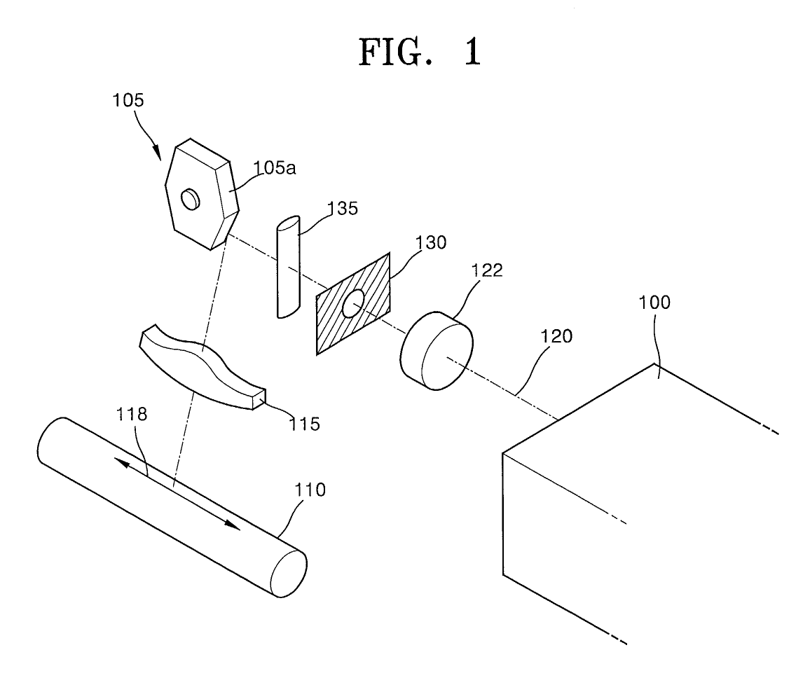

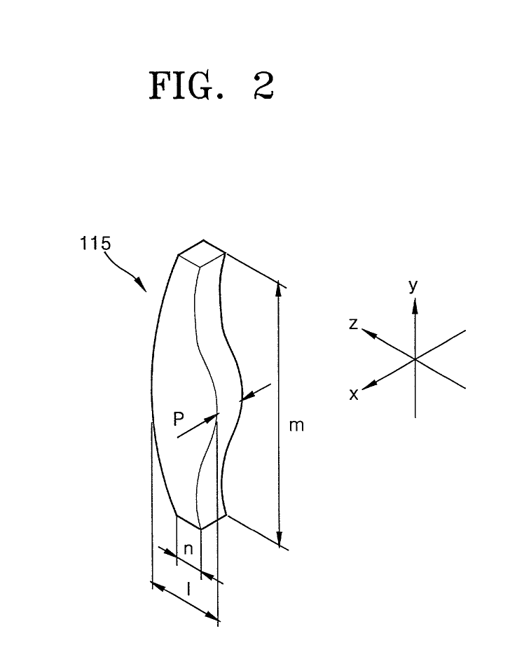

### DETAILED DESCRIPTION OF THE INVENTION

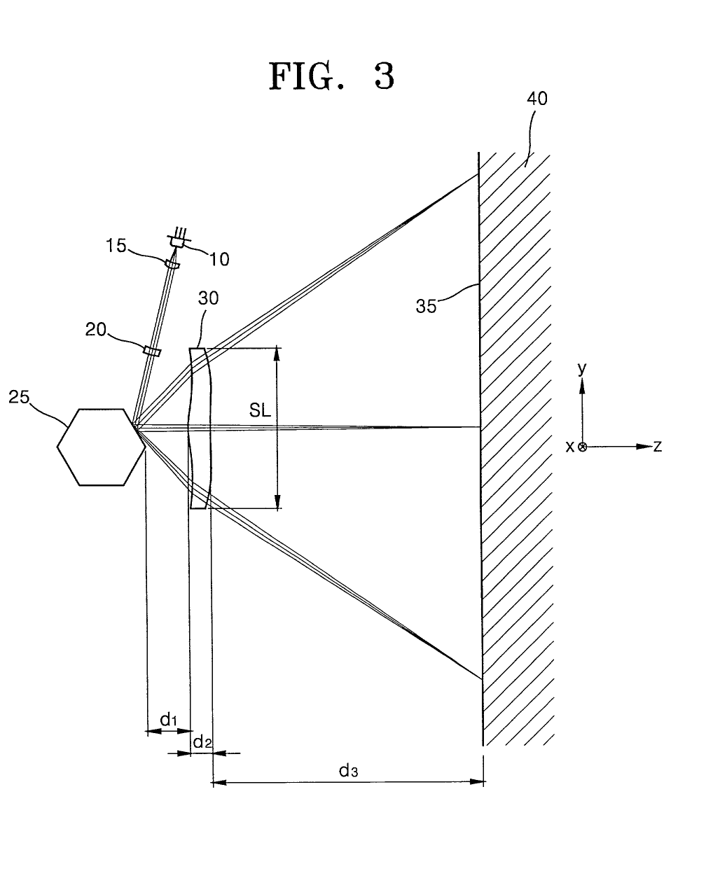

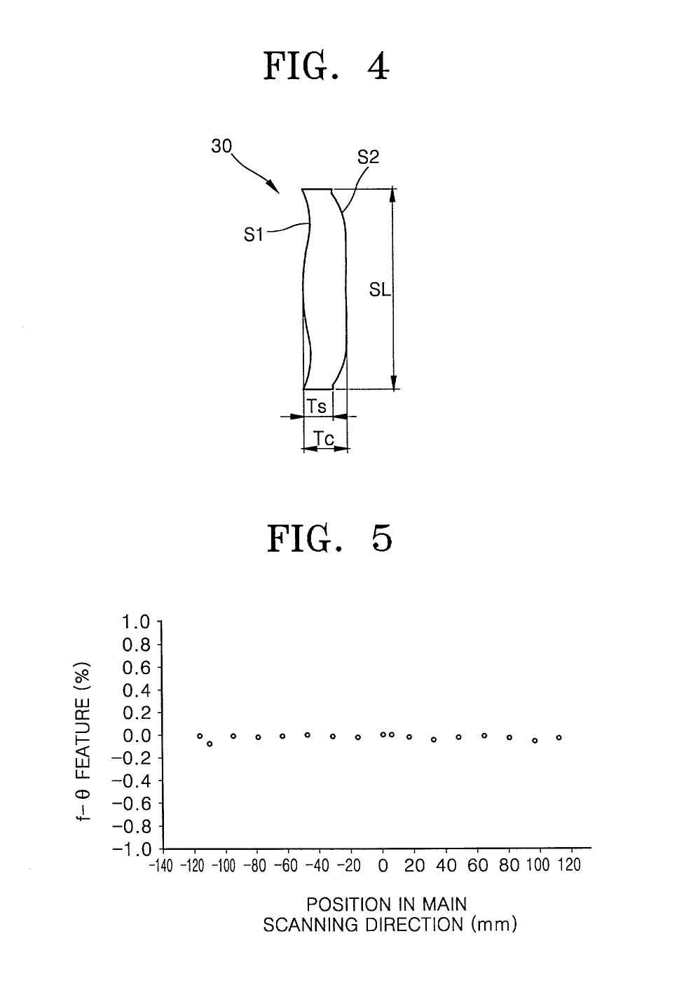

Referring to FIG. 3, an optical scanning apparatus according to the present invention includes a light source 10 for emitting light, a deflector 25, rotated by a motor (not shown), for reflecting the light emitted from the light source 10, and a scanning lens 30 for receiving the light reflected by the deflector 25 and forming an appropriate light spot according to a scanning line 35 on a photosensitive medium 40. Here, Z direction, Y direction, and X direction denote an optical axis direction, a main scanning direction, and a sub-scanning direction which is perpendicular to the main scanning direction, respectively. Also, reference numeral 15 denotes a collimating lens and reference numeral 20 denotes a cylindrical lens.

The scanning lens 30 is a toric lens and is formed such that the thickness Tc thereof at the center of scanning is not more than 1.5 times with respect to the thickness Ts of the scanning lens 30 at the edge of scanning. The above relationship is expressed as follows.

(T_{C}/T_{S})≦1.5 [Equation 1]

Also, the length SL of the scanning lens 30 in the main scanning direction is preferably formed to be less than 60 mm. Given that the radius of curvature, a cone constant and an aspheric coefficient on the optical axis of the scanning lens 30 in the main scanning direction (Y direction) are R, K and A2, A3, A4, . . . , respectively, the following equation is established.

$$z = \frac{{y}^{2}}{R \times \{ 1 + \sqrt{1 - ( 1 + k ) ( {y}^{2} / {R}^{2} )} \}} + {A}_{2} {y}^{2} + {A}_{3} {y}^{3} + ⋯ \qquad [ Equation 2 ]$$

Here, x, y, and z denote positions in the sub-scanning direction, the main scanning direction, and the optical axis direction, respectively. Also, given that the radius of curvature and aspherical coefficient on the optical axis in the sub-scanning direction (x direction) of the scanning lens 30 are r and B2, B3, B4, . . . , respectively, the shape r′ in the sub-scanning direction is expressed as follows.

$${r}^{′} = \frac{{x}^{2} \times ( 1 + {B}_{2} {y}^{2} + {B}_{3} {y}^{3} + ⋯ )}{r \times \{ 1 + \sqrt{1 - {\{ ( x / r ) \times ( 1 + {B}_{2} {y}^{2} + {B}_{3} {y}^{3} + ⋯ ) \}}^{2}} \}} \qquad [ Equation 3 ]$$

Here, the curvatures of incident surface S1 and exhaust surface S2 of the scanning lens 30 in the main scanning direction are positive values, and the curvatures of the toric incident surface S1 and convex exhaust surface S2 of the scanning lens 30 in the sub-scanning direction are negative values.

Next, a preferred embodiment of the scanning lens 30 having the above structure is shown as follows.

<Preferred embodiment 1 >

Wavelength (λ) in use: 780 (nm)

Distance (d1) from the deflector to the scanning lens: 28.5 (mm)

Thickness (d2) of the scanning lens at the center thereof: 11 (mm)

Distance (d3) from the scanning lens to the scanned surface: 134 (mm)

Shape of the scanning lens

First surface (incident surface) R: 65.732

| | | | |
|---|---|---|---|
| Ku: | −27.932 | Kd: | −27.966 |
| A4u: | −3.7574E−6 | A4d: | −3.6686E−6 |
| A6u: | 2.5386E−9 | A6d: | 1.8003E−9 |
| A8u: | −2.5319E−12 | A8d: | −3.0273E−12 |
| A10u: | −7.8953E−16 | A10d: | −1.3467E−15 |
| r: | −30.950 | | |

Second surface (exhaust surface) R: 201.900

| | | | |
|---|---|---|---|
| Ku: | −328.900 | Kd: | −254.800 |
| A4u: | −5.1489E−6 | A4d: | −5.4541E−6 |
| A6u: | 2.7446E−9 | A6d: | 3.2485E−9 |
| A8u: | −1.7389E−12 | A8d: | −2.7156E−12 |
| A10u: | −1.7860E−16 | A10d: | −4.8625E−16 |
| r: | −11.991 | | |
| B3u: | 1.0001E−4 | B3d: | 1.5687E−4 |
| B4u: | −1.3616E−5 | B4d: | −2.1503E−5 |
| B5u: | 8.6104E−7 | B5d: | 1.3543E−6 |
| B6u: | −2.9992E−8 | B6d: | −4.6998E−8 |
| B7u: | 5.4146E−10 | B7d: | 8.5745E−10 |
| B8u: | −3.9688E−12 | B8d: | −6.4715E−12 |

In the above preferred embodiment 1, where fluff is “up” and “d” is “down, the curvature of the scanning lens 30 in the sub-scanning direction continuously changes as the position of the lens changes in the main scanning direction. The scanning lens 30 is formed of plastic material and has a free curved surface, and meets an f-θ feature of not more than 0.1%, that is, scan linearity. Since wavefront aberration satisfies performance within 0.03 wave, aberration performance at the scanned surface meets optical performance at least 600 dpi.

The experiment result of the above preferred embodiment is shown in FIG. 5. Here, a horizontal axis denotes the distance in the main scanning direction and the vertical axis denotes the is f-θ feature when a light spot is focused on the scanned surface. It can be seen from the graph that the f-θ feature is not more than 0.1% and that the f-θ feature is superior.

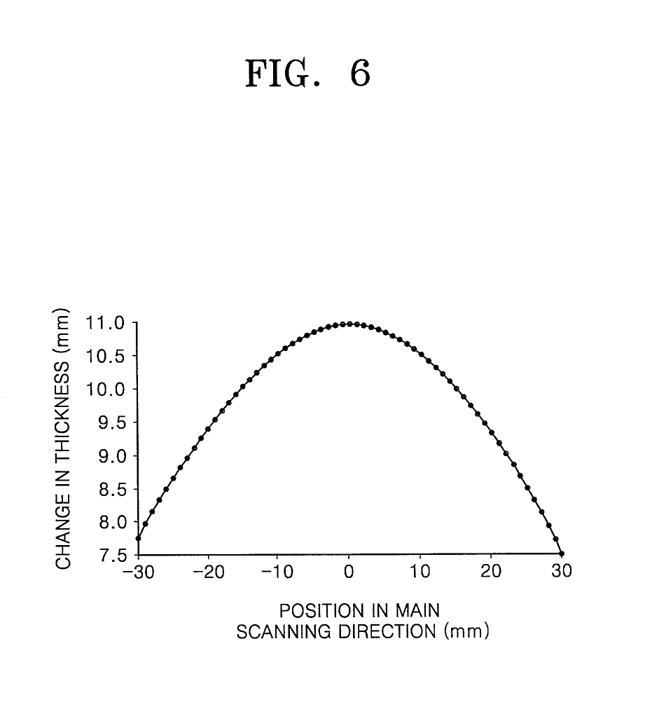

FIG. 6 shows the change in thickness of the scanning lens 30 with respect to the main scanning direction, in which the maximum useful length of the scanning lens 30 in the main scanning direction (x direction) is set to be less than 60 mm. Here, the ratio of the thickness of the center of the scanning lens 30 with respect to the thickness of the edge thereof is about 1.4. Thus, the structure of the scanning lens 30 having the above structure becomes compact, which is very advantageous for a mold process and lens manufacturing and less affected by a change in the external environment such as humidity and temperature.

As described in the above, in the optical scanning apparatus according to the present invention, since the scanning lens is formed of one unit and the optical surface thereof is a free curved surface, the thickness of the scanning lens at the center is not more than 1.5 times with respect to the thickness at the edge thereof, a difference in pressure at each of the scanning positions generated during the manufacture of the scanning lens is remarkably reduced so that the optical surface which is a free curved surface can be accurately controlled. Also, since the influence by birefringence and internal stress can be minimized, the competitiveness of a product in the cost is improved. Furthermore, since the structure of the scanning lens is less affected by the change in the external environment such as heat characteristic, humidity and temperature, performance of a product is improved.

What is claimed is:

1. An optical scanning apparatus comprising:
a light source for emitting light;
a deflector, rotated by a motor, for reflecting the light emitted from the light source; and
a scanning lens for receiving the light reflected by the deflector and forming an appropriate light spot according to a scanning line on a photosensitive medium, wherein the ratio between the thickness Tc of the scanning lens at the center thereof and the thickness Ts at the edge thereof satisfies the equation (T_{C}/T_{S})≦1.5.

2. The apparatus as claimed in claim 1, wherein the length (SL) of the scanning lens in a main scanning direction satisfies that SL<60 mm.

3. The apparatus as claimed in claim 2, wherein the curvature of the scanning lens in a sub-scanning direction continuously changes as the position of the lens changes in the main scanning direction.

4. The apparatus as claimed in claim 2, wherein the scanning lens is manufactured by plastic molding.

5. The apparatus as claimed in claim 2, wherein the curvature of the scanning lens in the main scanning direction has positive shapes for incident surface and exhaust surface and the curvature of the scanning lens in the sub-scanning direction has negative shapes for the incident surface and the exhaust surface.

6. The apparatus as claimed in claim 1, wherein the curvature of the scanning lens in a sub-scanning direction continuously changes as the position of the lens changes in the main scanning direction.

7. The apparatus as claimed in claim 1, wherein the scanning lens is manufactured by plastic molding.

8. The apparatus as claimed in claim 1, wherein curvatures of incident surface and exhaust surface of the scanning lens in the main scanning direction are positive values and curvatures of the incident surface and the exhaust surface of the scanning lens in the sub-scanning direction are negative values.

9. An optical scanning apparatus comprising:
a light source;
a photosensitive medium; and
a scanning lens for receiving light generated by said light source and forming an appropriate light spot on said photosensitive medium, said scanning lens having a thickness along an optical axis thereof no greater than 1.5 times a thickness of a peripheral edge thereof.

10. The optical scanning apparatus as set forth in claim 9, further comprising:
a collimating lens for converting the light generated by said light source into a parallel light beam;
a cylindrical lens for converting the parallel light beam to a convergent light beam; and
a deflector having a reflecting surface on which a linear image is formed by said convergent light beam, said deflector deflecting said convergent light beam onto said scanning lens.

11. The optical scanning apparatus as set forth in claim 9, wherein said scanning lens is a toric lens.

12. The optical scanning apparatus as set forth in claim 10, wherein said scanning lens has, in a direction of said optical axis, an incident surface nearest said deflector and exhaust surface nearest said photosensitive medium, said incident surface having a toric shape and said exhaust surface having a convex shape.

13. The optical scanning apparatus as set forth in claim 12, wherein a curvature of the scanning lens in a main scanning direction has positive shapes for the incident surface and the exhaust surface and a curvature of the scanning lens in a sub-scanning direction has negative shapes for the incident surface and the exhaust surface.

14. The optical scanning apparatus as set forth in claim 9, wherein the scanning lens is manufactured by plastic molding.

15. The optical scanning apparatus as set forth in claim 9, wherein a length of the scanning lens in a main scanning direction is less than 60 mm.

16. The optical scanning apparatus as set forth in claim 11, wherein the scanning lens is manufactured by plastic molding.

17. The optical scanning apparatus as set forth in claim 11, wherein a length of the scanning lens in a main scanning direction is less than 60 mm.

18. The optical scanning apparatus as set forth in claim 17, wherein said scanning lens has, in a direction of said optical axis, an incident surface nearest said deflector and exhaust surface nearest said photosensitive medium, said incident surface having a toric shape and said exhaust surface having a convex shape.

19. The optical scanning apparatus as set forth in claim 18, wherein a curvature of the scanning lens in the main scanning direction has positive shapes for the incident surface and the exhaust surface and a curvature of the scanning lens in a sub-scanning direction has negative shapes for the incident surface and the exhaust surface.
